(19) United States
(12) Patent Application Publication
(10) Pub. No.: US 2003/0183044 A1
(43) Pub. Date: Oct. 2, 2003

(54) Seal removal tool for stopper-closed vessels or bottles

(76) Inventors: H. Frank Entwisle, Nicholasville, KY (US); Edward H. Howell III, Nicholasville, KY (US)

Correspondence Address: H. FRANK ENTWISLE, 201 CAMBRIDGE LANE, NICHOLASVILLE, KY, 40356, US

(21) Appl. No.: 10/393,667

(22) Filed: Mar. 24, 2003

Related U.S. Application Data
(60) Provisional application No. 60/367,529, filed on Mar. 26, 2002.

(51) Int. Cl. B67B 7/04

(52) U.S. Cl. 81/3.47

(57) ABSTRACT

The seal removal tool quickly and easily removes wax seals or other wax-like materials utilized as seals or decorative adornment on narrow neck, stopper-closed bottles such as wine bottles and the like. Removal of the wax seal prior to extracting the bottle stopper eliminates contamination of the stopper-extracting device, typically a corkscrew, by all or a portion of the seal. The operation of the tool can be accomplished by persons of right-handed or left-handed dominance. Seal removal is accomplished by one or more sequential operations utilizing various unique elements of the tool.

### PRIOR APPLICATION

Provisional application No. 60-367,529

Title of application was: A seal removal tool for stopper-closed vessels or bottles

### BACKGROUND OF THE INVENTION

Bottles, including wine bottles and the like, are often closed with stoppers constructed of cork or an elastomeric compound. Producers of products contained in such bottles augment the stoppers sealing effectiveness and decorative appearance with exterior, both neck and stopper, coverings of foil or foil-like plastic or with poured hot wax seals or plastic or wax seals which are pre-formed and bonded to the stopper and/or bottle interior surface of the neck.

Exterior augmentary seals interfere with proper utilization of stopper extraction devices such as corkscrews. Several devices have been patented and are in general use for exterior (foil) seal removal.

Interior seals of poured hot wax or bonded materials similarly hamper proper stopper extraction and if extraction is successful, the seals often separate from the stopper and require an additional operation to remove the seal from the stopper extraction device.

Additionally, during stopper extraction with an interior seal in place, seal material will often adhere to the stopper-extracting device and impede further utilization of the device during subsequent stopper extraction.

Prior to the invention of this seal removal tool other concepts were investigated and rejected as unacceptable. The concepts rejected related to rotary cutters such as those containing cutting blades, shavers and augers as well as rotary seal grasping and shearing devices.

Rotary cutting devices readily removed the seal however the process of shaving and cutting away portions of a seal produced a prodigious amount of small seal remnants which were required to be collected and disposed of at a later time or which clogged and reduced the efficiency of subsequent seal removal attempts.

Grasping a seal and attempting to remove it in a rotary fashion by means of piercing pins removed certain styles of adhesive applied pre-formed seals in an acceptable manner but produced unacceptably high unit forces in hot-poured wax seals which merely resulted in removing annularly shaped segments of a seal and failed to shear the seal bonds to the stopper and to the bottle inner neck.

### BRIEF SUMMARY OF THE INVENTION

This seal removal tool easily and cleanly removes wax and bonded seals by prying, cutting and shearing the bond between the seal, bottleneck interior surface and stopper.

The tool imparts various forces on the wax seal of a stoppered bottle during sequential operations to break seal bonding to both the stopper and the bottle. Thorough and clean seal removal then allows subsequent unhampered insertion of a stopper removal tool. Subsequent stopper removal can then be accomplished without the contamination to the stopper removal device caused by attempted stopper removal with a seal remaining in place. Use of the seal removal tool eliminates the necessity for an additional time consuming operation to clear a seal from a stopper removal tool following stopper extraction.

### BRIEF DESCRIPTION OF THE DRAWINGS

Other objects and advantages of the invention will become more apparent upon perusal of the detailed description thereof and upon inspection of the drawings in which:

FIG. 1 is a plan view of the seal remover tool in position on a wine bottle with penetrator portion of the tool shown below the wax seal; and

FIG. 2 is a sectional side view of the tool in place on a wine bottle with the penetrator and cutting blade below the wax seal; and

FIG. 3 is a sectional view similar to FIG.2 and shows initial insertion of the penetrator between the bottle rim and the wax seal; and

FIG. 4 is a sectional view similar to FIG. 3 and shows the seal remover tool rotated to a horizontal position with penetrator now below the wax seal.

FIG. 5 is a plan view similar to FIG. 1 and shows that the seal remover tool can be rotated clockwise relative to the bottle to shear the bond between the seal and the stopper and the seal and the bottle rim. The seal remover tool can also be rotated counter-clockwise (not shown) to effect seal removal in a similar manner.

FIG. 6 is a plan view of a modified form of construction that incorporates the penetrator, locating pads, handle and thumb rest into open lattice wire-formed and welded construction. All elements of the tool are present and the function is exactly as demonstrated in FIGS. 1 through 5.

FIG. 7 is an elevation view of a modified form of construction that incorporates the penetrator, locating pads, handle and thumb rest into open lattice wire-formed and welded construction. All elements of the tool are present and the function is exactly as demonstrated in FIGS. 1 through 5.

FIG. 8 is a plan view of a simplified, single element modified form of construction of the tool that could be configured for utilization by either right-handed or left-handed dominant users (left hand shown). The penetrator remains unchanged in design and utility but this configuration incorporates a single locating pad. To retain stability for the user during wax seal removal, the single element variant incorporates finger-gripping indentations into the handle area of the tool, FIG. 8, 25. The function of the tool is exactly as demonstrated in FIGS. 1 through 5.

FIG. 9 is an elevation view of a simplified, single element modified form of construction of the tool that could be configured for utilization by either right-handed or left-handed dominant users (right hand shown). The penetrator remains unchanged in design and utility but this configuration incorporates a single locating pad. To retain stability for the user during wax seal removal, the single element variant incorporates finger-gripping indentations into the handle area of the tool. The function of the tool is exactly as demonstrated in FIGS. 1 through 5.

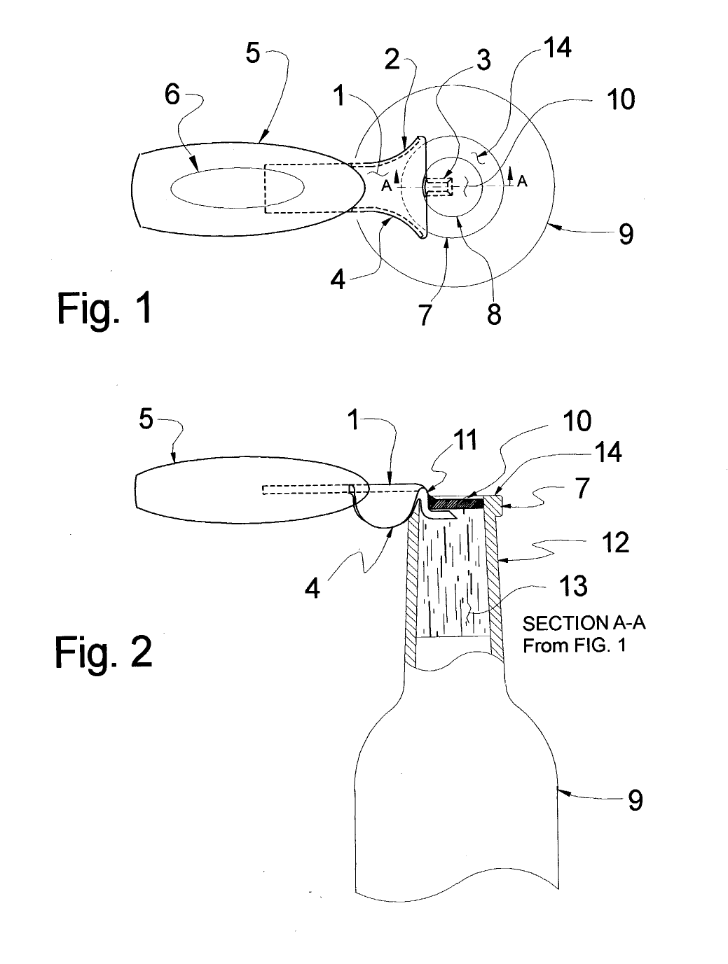

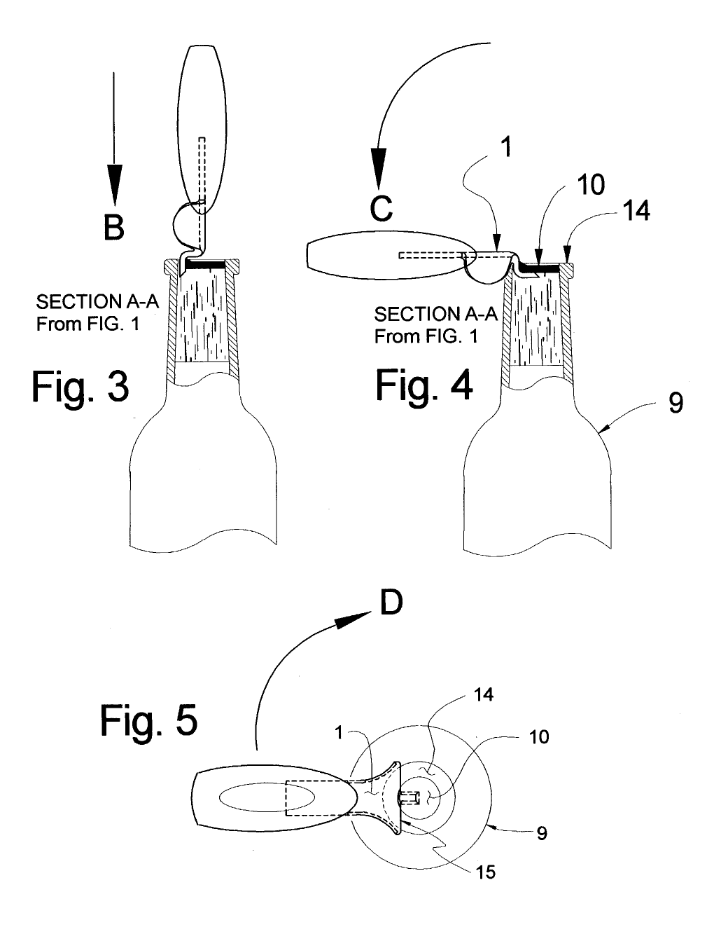

### DETAILED DESCRIPTION OF THE INVENTION

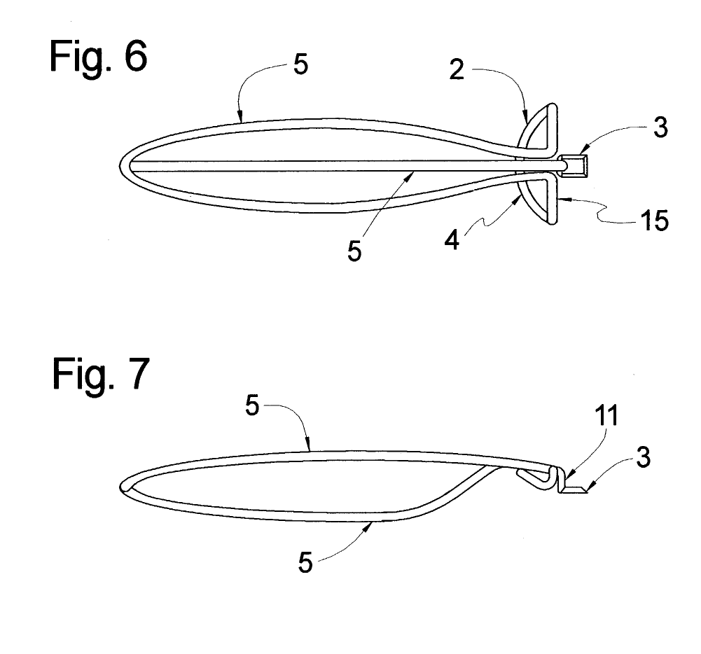

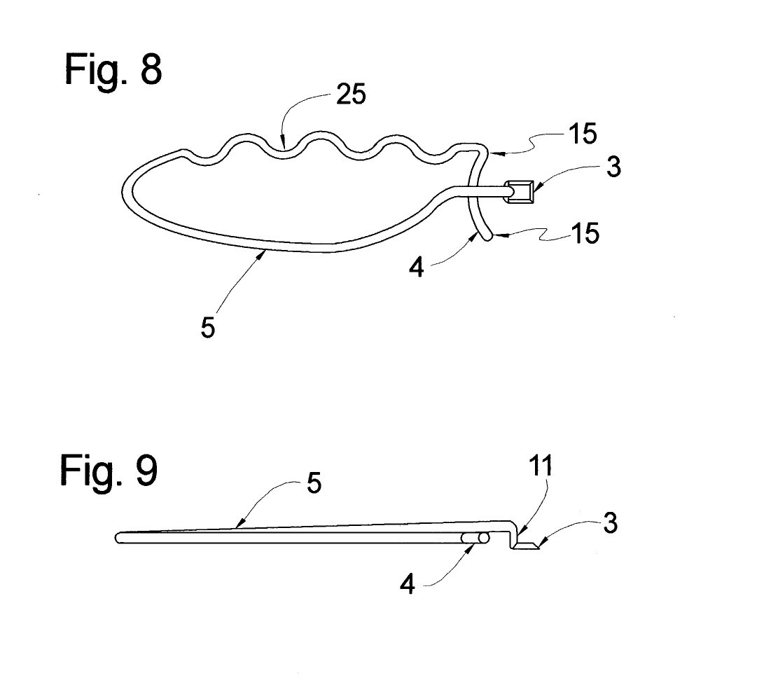

Referring now to the drawings in greater detail, there is illustrated therein the seal removal tool for stopper closed vessels or bottles made in accordance with the teachings of the present invention and generally identified by reference numeral 1. The tool is typically formed from stainless steel or mild steel with corrosion resistant plating. The handle of the tool is typically formed of wood, plastic, metal or other suitable material. A simplified modified form of construction would incorporate all elements of the tool into one or two mild or stainless steel wire components as shown in FIGS. 6, 7, 8 and 9.

The first operation (see FIG. 3) incorporates downwardly insertion FIG. 3 ARROW DIRECTION B of an angularly sharpened penetrator 3, which distorts and displaces a portion of the seal 10 allowing vertical positioning of the penetrator 3 against the inner portion of the neck of the bottle 8, which initializes separation of the seal 10 to internal bottleneck bond. The penetrator is limited in its vertical travel by contact between the depth limiter 15, (see FIGS. 5, 6, AND 8) through contact with the bottle top surface 14 to avoid excessive penetration into the stopper 13. If the seal is not removed at this operation, the tool is rotated to a horizontal position. FIG. 4 ARROW DIRECTION C

Horizontal positioning of the tool imparts radial and axial forces on the seal 10 through a cam surface FIG. 2, 11 incorporated into the base of the penetrator 3 tending to further separate the bond between the seal 10 and interior bottle neck 8 and initiates separation of the seal 10 to stopper 13 bond.

In the event that the seal 10 continues to remain adhered in place or is only partially removed, the tool 1 may be held statically in the horizontal position while the bottle 9 is rotated either in a clockwise or counter-clockwise direction. See FIG. 5. This rotation of the bottle 9 then separates the seal bond between the interior bottleneck 8 and bottle stopper 13 by benefit of angularly shaped cutting surfaces on the distal and medial portions of the penetrator 3.

As an alternative seal removal method, the bottle 9 may be constrained statically and the tool rotated about the center of the stopper 13 in a clockwise or counter-clockwise direction. These two alternative methods of utilization readily accommodate various persons' individual preferences and persons of either right or left-handed dominance.

The tool 1 maintains proper alignment with bottles of varying neck dimensions 7, 8, 12 during bottle rotation through contact with both the uppermost portion of the bottle 7 and the lateral portion 14 of the neck. Proper alignment of the tool 1 is assured by angular elements of the tool comprising of locating pads 2, 4. Two pads are incorporated to assure proper alignment during both clockwise and counter-clockwise bottle rotation and during operation of the tool 1 by both right and left-handed dominant persons. During all operations the 2 locating pads 2, 4 provide stability, comfort and convenience in tool utilization through their additional function as a thumb rest.

Further stability and relative tool-to-bottle relationship is enhanced by contact between the bottle upper lip 14 and the flat alignment plane of the tool 1.

The seal removal tool 1 incorporates a handle 5 typically made from wood, plastic or metal which comfortably accommodates usage by persons of right or left handed dominance. The handle 5 provides for convenient vertical thrust FIG. 3 ARROW B to engage the penetrator 3 between bottleneck 8 and wax seal 10. Further the handle 5 provides a convenient means to rotate the tool 1 from vertical, FIG. 3 ARROW B to horizontal orientation, FIG. 4 ARROW C, and to rotate the tool 1 in a horizontal plane, FIG. 5 ARROW D thus effecting complete removal of seal 10 from bottle 9.

The handle 5 of the tool 1 may be configured to not only provide an efficient and pleasing shape for secure gripping of the tool but also to accommodate an area 6 dedicated to text or pictorial elements such as advertising or promotional information.

Breaking and cutting of the seal's bond between the bottle inner neck 8 and stopper 13 allows easy insertion of a stopper extraction tool such as a corkscrew or the like.

Absence of the seal 10 during stopper 13 extraction results in maintaining a clean, effective stopper extraction tool and eliminates the necessity for removing not only the stopper 13 from the stopper remover but also the seal 10 which often separates from the stopper 13 during the extraction process.

What we claim as our invention is a seal removal tool for stoppered narrow neck vessels such as wine bottles and the like comprised of:

1. A tool with a suitable handle for use by right-handed and left-handed dominant persons.

2. A tool incorporating multiple elements that produce prying, cutting and shearing forces in axial, radial and circumferential directions to facilitate seal removal.

3. A tool to distort and pry a seal away from the bond to the bottle and stopper.

4. A tool incorporating 2 angularly arranged locating pads to accommodate bottles of varied diameter and thickness.

5. A tool incorporating 2 angularly arranged locating pads to serve as thumb rests during operation.

6. A tool incorporating a functional handle of a material suitable for display of advertising or promotional text or pictorial content.
